(19) United States
(12) Patent Application Publication
(10) Pub. No.: US 2026/0127087 A1
(43) Pub. Date: May 7, 2026

(54) METHOD AND APPARATUS FOR IMPLEMENTING A SELECTOR MECHANISM TO DETERMINE A GENERATIVE AI ENTITY BASED ON SPECIFIC TASK REQUIREMENTS

(71) Applicant: PRICEWATERHOUSECOOPERS LLP, Toronto (CA)

(72) Inventors: Vik PANT, Toronto (CA); Bahar SATELI, Montreal (CA)

(21) Appl. No.: 19/375,364

(22) Filed: Oct. 31, 2025

(30) Foreign Application Priority Data
Nov. 1, 2024 (CA) 3256853

(51) Int. Cl. G06F 11/34; G06F 11/32; G06N 3/0475

(52) U.S. Cl. CPC G06F 11/3409; G06F 11/323; G06N 3/0475

(57) ABSTRACT

A non-transitory computer-readable storage medium, comprising instructions which, when executed by one or more processors, configure the one or more processors to implement a Generative AI entity selector mechanism including, an input configured for receiving a user request intended for a Generative AI entity to elicit an output from the Generative AI entity, selection logic configured for processing the user request to select a Generative AI entity from the set of Generative AI entities for servicing the user request and an output for generating a selection signal, which conveys an identification of the Generative AI entity selected by the selection logic.

### CROSS-REFERENCE TO RELATED APPLICATION

The present application claims the priority of Canadian Patent Application No. 3,256,853, filed on Nov. 1, 2025 and incorporated herein by reference.

### FIELD OF THE INVENTION

The present invention relates to the field of Generative AI entities and to methods and systems for the management of such Generative AI entities. More specifically, the invention relates to a computer implemented selector mechanism configured to select a Generative AI entity among a plurality of Generative AI entities, and to optionally route a user request to the selected Generative AI entity for processing and output generation. Optionally, the invention integrates a dynamic feedback mechanism, enabling continuous learning and adaptation of the selector mechanism based on operational performance and user satisfaction metrics, thereby progressively enhancing the efficacy and precision of the Generative AI entity selection process over time.

### BACKGROUND OF THE INVENTION

Generative AI entities offer numerous economic benefits that contribute to enhanced productivity, efficiency, and innovation across various industries. These entities can automate and optimize processes, leading to cost savings and increased output. For instance, in content creation and marketing, Generative AI can generate personalized advertisements, product descriptions, or social media content at scale, reducing the time and resources required for manual content production. In manufacturing, Generative AI can assist in designing and optimizing complex products, leading to improved efficiency and reduced material waste. Furthermore, Generative AI entities can facilitate data analysis and decision-making by quickly generating insights from vast amounts of information, enabling businesses to make data-driven decisions with greater speed and accuracy. Overall, the adoption of Generative AI entities has the potential to drive economic growth, foster innovation, and create new opportunities in diverse sectors.

Generative AI entities exhibit a range of operational performances and associated usage costs, influenced by various technical and computational factors. Commonly, these entities adopt a revenue model that is predicated on a per-token charging basis. In this context, a token is defined as the fundamental unit of language processed by a Generative AI entity, representing a discrete element of input provided by the user. This unit can encompass an entire word, symbol, or a segment of a word within a given input sentence.

The intricacy of a user's request has a direct correlation with the number of tokens required for processing. As such, more complex requests necessitate a greater token count, leading to an increment in the operational cost for that specific user interaction. This cost variability is integral to the system's design, ensuring that the pricing structure is reflective of the computational resources and processing time expended.

In technical terms, the token-based billing model aligns the cost to the computational intensity and complexity of the language processing task. This approach allows for a flexible and scalable pricing strategy, accommodating a wide range of user needs from simple queries (e.g., closed-form questions) to more elaborate and demanding requests (e.g., question answering using contextual information). Consequently, users engaging with more advanced or extensive interactions with the Generative AI entity can expect a proportional increase in the cost, mirroring the higher level of resource utilization and processing time required by the system to fulfill such requests.

A notable feature in many Generative AI entities is the incorporation of a dynamic feedback mechanism. This mechanism facilitates continuous learning and refinement of the system's Large Language Model (LLM) during usage. The evolving nature of the LLM, fostered by real-time user interactions and feedback, contributes to the progressive enhancement of the system's performance. However, this evolutionary aspect introduces a degree of unpredictability in the system's outputs. For instance, there is a potential for the development of biases within the LLM or impact their output through runtime attacks, necessitating monitoring and proactive intervention by the system operators to mitigate such tendencies.

In contrast, there is also a category of Generative AI entities that include static variants, which do not employ a dynamic feedback loop. In these static systems, the LLM remains unchanged post-deployment. While the absence of ongoing learning capabilities limits the system's ability to adapt and improve over time, it also provides a higher degree of predictability in terms of output. Once a static Generative AI entity is commissioned and its operational characteristics, such as bias tendencies, are thoroughly understood, these traits remain consistent over its operational lifespan. This stability translates into reduced requirements for active monitoring and management, as the behavior of the system is established and remains relatively constant, providing a more predictable and controlled operational environment.

Static Generative AI architectures also offer the feasibility of on-premises deployment, assuming the requisite IT (Information Technology infrastructure is available. This model can present a more cost-efficient option compared to cloud-based, dynamically adaptive Generative AI entities.

Finally, the behavior of Large Language Models can be modified during their runtime through configuring a set of parameters, such as ‘temperature’ serving as a parameter influencing the balance between the model's predictability and creativity (randomness). Such parameters are either decided during deployment (for all future queries) or during application time on a per query basis. For example, for content generation a user may want to set a high temperature to generate creative output, while for a question answering system the temperature should be close to zero to avoid quality defects such as hallucination or misrepresentation of information. Therefore, it may be desirable that different configuration of the same LLM is decided and used at runtime.

Considering the above, there is a recognized demand within the industry for a spectrum of Generative AI solutions tailored to varying user requirements along with a selection mechanism that enables the selection or recommendation of a Generative AI solution most aligned with the specific operational requirements.

### SUMMARY OF THE INVENTION

As embodied and broadly described herein, the invention provides a non-transitory computer-readable storage medium, comprising instructions which, when executed by one or more processors, configure the one or more processors to implement a Generative AI entity selector mechanism including an input configured for receiving a user request intended for a Generative AI entity to elicit an output from the Generative AI entity. The selector mechanism is configured to process the user request and select a Generative AI entity among a plurality of Generative AI entities. The selector mechanism includes an output configured to release a selection signal, indicative of a selected Generative AI entity.

A Generative AI entity, also known as a Generative model, is a type of artificial intelligence that is designed to generate new data samples that resemble a given dataset. It is a class of AI models capable of learning the underlying patterns and structures of the training data and then using that knowledge to produce new, synthetic data that resembles the original data distribution.

In a specific, non-limiting embodiment of the invention, the selector mechanism incorporates a selection logic that processes a user request to determine the most suitable Generative AI entity from a plurality of such entities for fulfilling the user request. This selection logic generates a selection signal representing the decision made. Specifically, the selection process involves two sequential stages. Initially, the user request is processed to generate a ranking based on one or more metrics, with varying user requests potentially producing different rankings. Subsequently, a Generative AI entity is chosen from among the multiple entities available based on its suitability to meet the user request, with this choice being influenced primarily by the aforementioned rankings.

Rankings may be based on a single metric or multiple metrics. In scenarios involving multiple metrics, the ranking adopts a multi-dimensional approach. Selecting a Generative AI entity based on a multi-dimensional metric framework may necessitate a selection logic that attributes varying degrees of importance or influence to each metric. This methodology enables the selection of a Generative AI entity through consideration of multiple, potentially incompatible metrics. For instance, the lower cost of servicing a user request might conflict with the requirement for a Generative AI entity capable of handling complex requests. A selection logic capable of weighing various metrics offers an advantage by balancing these metrics to achieve a compromise selection that accounts for most, if not all, of the relevant metrics.

The various metrics can be categorized into distinct groups, each group consisting of multiple metrics. For instance, these groups may include extrinsic metrics and intrinsic metrics. Extrinsic metrics relate to parameters largely independent of the user request's fundamental nature. An example of an extrinsic metric includes the cost-per-token, which, for a given Generative AI entity, remains consistent regardless of variations in the complexity of the request. Additionally, latency is another extrinsic metric, wherein lower latency is generally preferred to expedite the production of outputs from a Generative AI entity. Furthermore, the predictability of the output could also qualify as an extrinsic metric. Static Generative AI entities, which lack significant feedback mechanisms to adapt the internal LLM networks, produce outputs that are consistently similar for identical inputs. In contrast, dynamic Generative AI entities, which undergo constant adaptation, demonstrate lower predictability, and may produce varying outputs over time for similar inputs. Therefore, in scenarios where reducing randomness in the output is important, the predictability metric may be employed to control the selector mechanism that prioritizes static over dynamic Generative AI entities by assigning a higher ranking to predictability, where the static Generative AI entity is known to exhibit reduced bias or information misrepresentation.

Extrinsic metrics, being generally unrelated to the essence of the user request, can be ranked according to preferences specified by either the user or administrator. For example, if cost is a critical factor, the cost-per-token rank may be specified by the user or administrator, and this parameter would then influence the selection process carried out by the selector mechanism in choosing a suitable Generative AI entity.

Conversely, intrinsic metrics are directly related to the substance of the user request and typically reflect the complexity inherent in the request. User requests may range from simple inquiries to more complex queries that necessitate a Generative AI entity capable of handling such complexity. In such cases, the ranking of intrinsic metrics is determined by conducting an analysis of the user request to identify its characteristics and subsequently assigning a ranking based on these properties. A variety of analytical techniques may be employed in this context, as will be discussed subsequently.

The selector mechanism is designed as a software-based module. In its primary operational model, this module executes a sequence of programmed instructions. These instructions are formulated to algorithmically analyze and interpret user requests, along with other relevant input parameters, to ascertain characteristics or features inherent in these requests, particularly intrinsic metrics. Based on this analytical process, the selector mechanism aligns the user request with an appropriate Generative AI entity.

For instance, when the algorithm categorizes a user request as relatively straightforward or simple, it delegates the task to a designated Generative AI entity. This selection decision is predicated on the understanding that the capabilities of a less sophisticated Generative AI entity are sufficient for the effective fulfillment of such straightforward requests. Conversely, in scenarios where the user request is evaluated as complex or demanding, the selector mechanism opts for a more robust and high-performing Generative AI entity, ensuring the request is handled with the requisite computational proficiency.

One immediate advantage of this selection process is the optimization of operational costs. By assigning simpler tasks to less resource-intensive AI systems, which are more cost-effective, the selector mechanism reduces the overall expenditure associated with the deployment of Generative AI solutions, particularly in cases where high-end systems are not always required.

In an alternative embodiment, the selector mechanism uses an Artificial Intelligence (AI) module, exemplified by a neural network-based classifier. This classifier is engineered to efficiently rank user requests based on one or several intrinsic metrics and possibly extrinsic metrics.

Upon receipt of a user request, the classifier determines the appropriate ranking for the request. This classifier-based architecture necessitates an initial training phase. This phase involves gathering a sufficient volume of training data, curated to ensure the classifier's proficiency in accurately matching user requests and optionally additional inputs, with ranking levels.

In an alternate embodiment within the domain of Artificial Intelligence solutions, a Generative AI entity can be used to determine the ranking in the context of a single metric or multiple metrics, by analyzing the user requests. This methodology exhibits considerable versatility, capable of addressing a diverse range of user requests and complex additional factors to make the most informed ranking determination. However, the utilization of a Generative AI entity for the ranking determination, prior to engaging another downstream Generative AI entity for servicing of the user request, introduces an additional cost and latency variables that warrant consideration.

Nonetheless, certain applications may find this dual-layered Generative AI framework advantageous. This is especially pertinent in scenarios where the ranking determination Generative AI entity is already accessible as a pre-existing, low-cost resource. In such cases, its deployment for the ranking determination can be economically viable.

It should be noted that the ranking determination does not necessitate a highly advanced Generative AI entity; a system with limited capabilities could be sufficient for this task. As a result, the incremental cost associated with this additional ranking determination layer is minimal. Despite the modest increase in expense, the benefits of this approach are tangible, particularly in terms of the enhanced flexibility and proficiency it offers in ensuring the most appropriate downstream Generative AI entity is engaged to address the user's request effectively and fully.

In the specified embodiment, the output resulting from the ranking process, which evaluates a user request based on either a single metric or a composite of metrics—including both intrinsic and extrinsic metrics—comprises a series of ranks, each rank reflecting the evaluation of the user request within the framework of a specific metric. In an illustrative example, this series of ranks is utilized to select a Generative AI entity from a pool of such entities, wherein the selected system's attributes are chosen to best match the assessed ranks. For instance, if the user request is highly rated on the extrinsic metric of cost-per-token, and similarly scores high on the intrinsic metric of complexity, in other words, the request is highly complex, yet the directive is to process the user request at relatively low cost, the selection mechanism considers both factors to identify a Generative AI entity that aligns to at least some degree with these criteria. Given that the demands of low cost and high complexity may be inherently conflicting, it is improbable that any single system will fully satisfy both; however, the selection process is tailored to harmonize these requirements and thus identify the most suitable solution.

The selection process for the Generative AI entity generates a selection signal, which is indicative directly or indirectly of the chosen or recommended Generative AI entity for servicing the user request. This selection signal may serve as an advisory function, assisting in the identification of the Generative AI entity to the system user or administrator that is best suited to fulfill the specific user request. Optionally, the selection signal is configured to automatically route a user request to the selected Generative AI entity. In this form of implementation, the selector mechanism optionally includes a routing mechanism that can dynamically direct the user request to the selected Generative AI entity identified by the selection signal. The routing mechanism can be implemented as a logical switch configured to present the user request to the selected Generative AI entity.

Examples of a selection signal can include an identifier of the specific Generative AI entity to service the user request, a ranking of the Generative AI entity pool to indicate which Generative AI entities in the pool are more suitable to service a user request or a user profile, an attribution of a user request category which is then associated to a Generative AI entity, a guided selection of an appropriate Generative AI entity via configuration signal, a conveyance of ranking of the user request in the context of one or several metrics, the designation of a Generative AI entity associated with an active output. It should be noted that other examples are possible without departing from the spirit of the invention.

In a further embodiment of the present invention, the selector mechanism is configurable via a configuration signal. This configuration signal serves as a factor in guiding the selection of an appropriate Generative AI entity for processing a particular user request(s) based on rankings. The inclusion of this configuration signal introduces a layer of administrative control, enabling the user or administrator to exert influence over the selection process based on specific operational preferences or requirements, either on a temporary or a more extended basis.

In one embodiment, a method for configuring the selector mechanism is provided, wherein the method comprises transmitting a configuration signal from an administrative control to the selector mechanism. The configuration signal is adapted to prioritize certain metrics of the user request over others. As an example, the configuration signal enables a user or administrator to prioritize the cost-per-token metric by configuring the selector mechanism to preferentially select Generative AI entities exhibiting lower operational costs over systems equipped with more sophisticated functionalities that generally incur higher costs.

In a specific example of implementation, the configuration signal is configured to assign relative weights to one or more evaluation metrics that influence the selection of the Generative AI entity. In a particular implementation, the configuration signal is configured to modulate the weighting attribute associated with the cost-per-token metric. This weighting attribute is set high, thereby disproportionately influencing the selection process in favor of the cost-per-token metric, such that the selection decision is biased towards selecting a Generative AI entity that minimizes cost-per-token.

The configuration signal may be adjusted through a Graphical User Interface (GUI) that incorporates control elements designed to receive user inputs. These inputs are utilized to define the relative significance of the various metrics that drive the selection decision.

As indicated previously, the selector mechanism outputs a selection decision. The selection decision is conveyed via the selection signal. In a specific example of implementation, the selection signal identifies the selected Generative AI entity in a pool of Generative AI entities.

Instead of using multiple Generative AI entities offering a range of different capabilities, it is possible to use a single Generative AI entity with an adaptable performance. In this example, a range of performance grades can be effectively achieved by adequately conditioning the Generative AI entity before submitting the user request, such that the user request is handled according to the desired performance grade. Such conditioning can be achieved via prompt engineering to provide instructions and guidance to the Generative AI entity in the way the request is to be handled, which corresponds to the selected performance grade. For example, prompt engineering can be used to condition the Generative AI entity such as to control the length of the response provided to the user request, which should impact cost-per-token.

Optionally, the selector mechanism includes a selector mechanism manager which manages and configures the operation of the selector mechanism. The selector mechanism manager is configured to capture, characterize, and assess the operational dynamics of the selector mechanism, such as by tracking and documenting various operational parameters, including but not limited to trends, events, and specific conditions that manifest within the selector mechanism over a designated period. This reporting function can gather a comprehensive array of operational data, encompassing both quantitative and qualitative aspects of the selector mechanism's performance. The data acquisition process is designed to be both granular and expansive, ensuring a thorough representation of the operational landscape. This data set could serve as training examples for request classification and automated routing.

Once the data is collected, the selector mechanism manager is optionally configured to perform data aggregation. This involves compiling the individual data points into a cohesive and structured format, thereby facilitating more effective analysis. After aggregation, the selector monitor can apply analytical techniques to the compiled data. This analysis is geared towards extracting meaningful insights from the operational data.

In a first specific example of implementation, the data conveying the one or more characteristics defines a usage profile of the use of the plurality of Generative AI entities wherein the usage profile establishes comparative frequency of utilization metrics among the plurality of Generative AI entities.

In a second specific example of implementation the data conveying the one or more characteristics conveys information about cost incurred for using one or more of the Generative AI entities, such as comparative cost metrics of utilization among the plurality of Generative AI entities.

In a third specific example of implementation, the data conveying the one or more characteristics establishes comparative latency metrics among the plurality of Generative AI entities.

In addition to its capabilities for data collection and reporting, the selector mechanism manager is also optionally configured for outputting the configuration signal used to regulate the operation of the selector mechanism. In this embodiment, the functions of data gathering, reporting, and configuration are integrated within a single functional module. The selector mechanism manager may interface with a dashboard to facilitate communication with the user or administrator. The reporting function is executed through this dashboard, which presents the collected data to the user or administrator for visualization. Furthermore, as previously mentioned, the dashboard may employ a GUI equipped with control elements designed to capture user inputs. These inputs are then used to generate the configuration signal.

As embodied and broadly described herein, the invention provides a non-transitory computer-readable storage medium, comprising instructions which, when executed by one or more processors, configure the one or more processors to implement a Generative AI entity selector mechanism including an input configured for receiving a user request intended for a Generative AI entity to elicit an output from the Generative AI entity, selection logic configured for processing the user request to select a Generative AI entity from the set of Generative AI entities for servicing the user request, and an output for generating a selection signal, which conveys an identification of the Generative AI entity selected by the selection logic.

As embodied and broadly described herein, the invention also provides a non-transitory computer-readable storage medium, comprising instructions which, when executed by one or more processors, configure the one or more processors for implementing a GUI for allowing a user to control a behavior of a Generative AI entity selector, including implementing on the GUI an input mechanism that provides a plurality of selection choices to modify an aspect of the behavior exhibited by the Generative AI entity selector. In response to user selection of a choice among the plurality of choices, deriving a selection configuration signal that influences a selection of a Generative AI entity among a plurality of Generative AI entities, by the Generative AI entity selector.

As embodied and broadly described herein, the invention further provides a method performed by one or more computers, comprising, receiving at an input of the one or more computers a user request, wherein the one or more computers implement a Generative AI entity selector mechanism for selecting a Generative AI entity to service the user request, among a set of Generative AI entities, the selector mechanism including selection logic configured for processing the user request and to generate as a result of the processing a selection signal and an output for releasing the selection signal.

As embodied and broadly described herein, the invention yet provides a method executed by one or more computers implementing a Generative AI entity selector mechanism, the method including:
a. receiving at an input of the one or more computers a user request intended for a Generative AI entity to elicit an output from the Generative AI entity;
b. processing the user request with a selection logic implemented by the one or more computers and configured for generating a selection signal conveying a selection of one or more Generative AI entities among a plurality of Generative AI entities for servicing the user request, and outputting the selection signal via an output
c. Implementing by the one or more computers a Generative AI entity selector monitor configured to output data conveying one or more characteristics of an operation of the Generative AI entity selector.

As embodied and broadly described herein, the invention further provides a method implemented by one or more computers configured for:
a. implementing a GUI for allowing a user to control a behavior of a Generative AI entity selector mechanism;
b. implementing on the GUI an input mechanism that provides a plurality of selection choices to modify an aspect of the behavior exhibited by the Generative AI entity selector;
c. in response to user selection of a choice among the plurality of choices, deriving a configuration signal that influences a selection of a Generative AI entity among a plurality of Generative AI entities, by the Generative AI entity selector mechanism.

### BRIEF DESCRIPTION OF THE DRAWINGS

FIG. 1 illustrates a schematic representation, in the form of a high-level block diagram, of a network cloud-based configuration, engineered for the implementation of a selector mechanism for performing the selective channeling of user requests towards a specifically chosen Generative AI entity made from a pool of diverse Generative AI entities, each distinguished by its unique set of capabilities or inherent characteristics. The diagram delineates the main components and their interconnections within this cloud infrastructure.

FIG. 2 is a flow-chart that illustrates at a high level the method of operation of the selector mechanism illustrated in FIG. 1;

FIG. 3 is a high-level block diagram of the selector mechanism illustrating the main components of the selector mechanism;

FIG. 4 illustrates a mapping between extrinsic rankings and operational profiles of Generative AI entities.

FIG. 5 depicts a block diagram of a neural network-based classifier configured for ranking user requests in accordance with a predetermined metric. This classifier architecture exemplifies one possible implementation of the selection logic within the system shown in FIG. 3;

FIG. 6 shows a block diagram illustrating an analysis module designed to analyze user requests for ranking them. The analysis module implements algorithmic techniques, artificial intelligence functionalities or a combination of both.

FIG. 7 is a variant of the analysis module shown in FIG. 6, where the analysis module performs an analysis of the user request across multiple metrics;

FIG. 8 illustrates a process flow of a process performed by the selector mechanism to assess user requests and store results of the assessment in a user profile;

FIG. 9 is a detailed block diagram of a selector mechanism manager;

FIG. 10 is a high-level diagram of a dashboard linked with the selector mechanism manager for data collection and reporting and for configuration of the selector mechanism.

FIG. 11 is a high-level block diagram of a decision logic module which is part of the selector mechanism.

### DESCRIPTION OF AN EXAMPLE OF IMPLEMENTATION

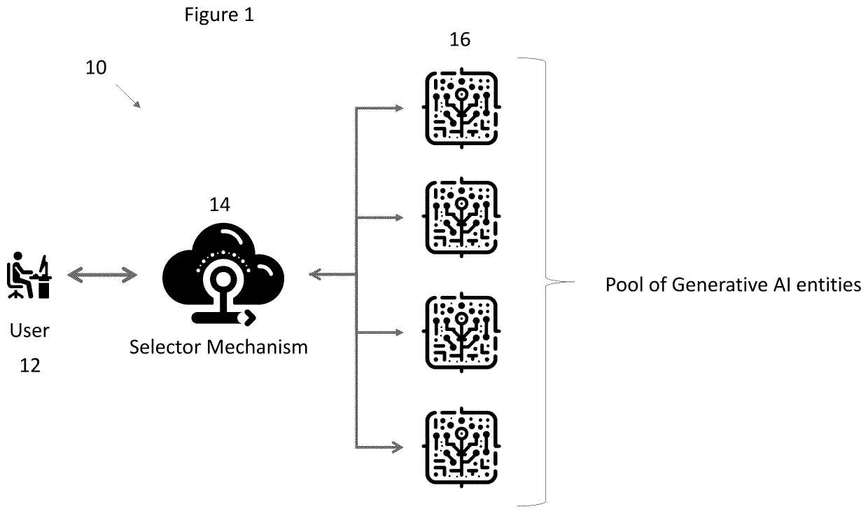

FIG. 1 is a high-level depiction of a cloud-based architecture of a system 10 comprising a selector mechanism 14 for selecting a Generative AI entity capability to service a user request and then optionally route the request to the Generative AI entity according to the selected entity. Selector mechanism 14 communicates with a user 12 via a user computer. The data communication is performed over a suitable data communication network, not shown, such as the Internet. It will be noted that in practice, system 10 would communicate with multiple users which reside at different network nodes, such that the system 10 receives a flow of user requests and then services those user requests, as it will be described below.

The selector mechanism 14 is a software-based entity that can be deployed in the cloud or on-premises. It necessitates an appropriate computing infrastructure equipped with the requisite data processing and storage solutions to host and run the selector mechanism software. Additionally, this selector mechanism 14 is provided with a network interface designed to interface with a data network, such as the Internet, accepting user requests and forwarding them to a Generative AI entity layer for processing.

This system 10, with the assistance of the selector mechanism 14, is configured to select the most appropriate Generative AI entity from a pool of such entities (referred collectively as Generative AI entities 16) based on the specific processing needs of each user request. This selection process is predicated on the distinct capabilities of each Generative AI entity within the pool, with some entities designed to tackle more complex inquiries or those necessitating specialized knowledge in particular fields.

In one deployment scenario, each Generative AI entity within this pool functions as an autonomous entity, complete with its dedicated hardware, software, and LLM. These autonomous entities are assigned unique network addresses, enabling the selector mechanism 14 to route user requests to the appropriate Generative AI entity by specifying its network location.

In an alternative embodiment, a configuration permits Generative AI entities to utilize shared resources, including a unified hardware platform and common software components. Differentiation among these entities is achieved through the employment of multiple LLM's, each providing distinct capabilities. When a user request with a specific performance requirement is received, the corresponding LLM is activated on the shared platform.

Within this framework, the selector mechanism 14, routes all requests to a singular network location. Accompanying each request is an indicator that specifies, either explicitly or indirectly, the appropriate LLM to be utilized for processing the request. A software module, functioning as an LLM manager, interprets this indicator to ensure that the correct LLM is engaged, thereby processing the request in accordance with the designated performance level.

In an alternative configuration, the array of Generative AI entities are virtual entities, powered by the same physical infrastructure and software framework. Within this setup, a singular LLM is utilized, but it is engineered to offer variable capability levels, based on the requirements of incoming user requests.

In this scenario, each user request conveys a virtual Generative AI identifier. This identifier is processed by a local LLM manager, which dynamically adjusts the operational parameters of the LLM to align with the requested capability level. For instance, the LLM manager may prepend a specific system prompt to the user's request. This prompt is chosen or crafted to modify the LLM's processing behavior to match the indicated capability level of the specified Generative AI virtual entity.

Such capability configuration system prompts could vary widely in their nature and effects. For example, they might limit the verbosity of the LLM's responses, ensuring that the output is concise and directly relevant to the user's query. Alternatively, prompts could guide the LLM to focus its response within a specific domain or to employ a certain reasoning style. Other examples might include prompts that encourage the LLM to prioritize speed over depth in its responses, or to utilize a specific set of data points or references when generating its output. This approach allows for a highly flexible and adaptable AI system that can cater to a broad spectrum of user needs and preferences with a single underlying LLM architecture.

It is also understood that a virtual Generative AI entity could be designed to have a cost of operation profile that is linked to the requested capability. For instance, when the capability of the virtual Generative AI entity is scaled down, the cost-per-token can be reduced. In contrast, when the requested capability is scaled up, such as by removing the limitations on capability introduced via prompt engineering, the cost-per-token would be increased.

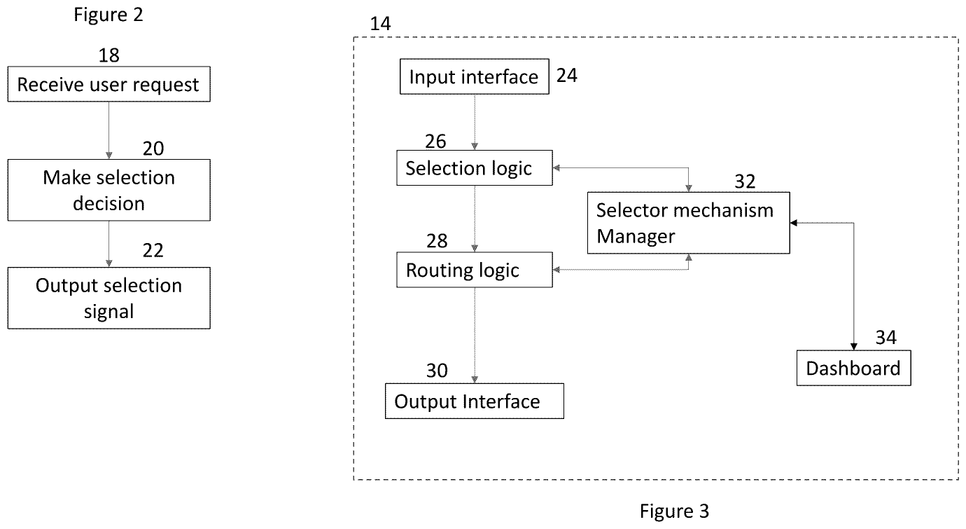

FIG. 2 is a high-level flow chart which illustrates the operation of the selector mechanism 14. The process flow starts at step 18 where a user request is received at the input of the selector mechanism 14. At step 20, the selection logic processes the request and selects the Generative AI entity that best matches the user request. At step 22, the selector mechanism 14 outputs the selection signal which conveys the results of the selection operation. The selection signal can explicitly specify the Generative AI entity that is found to best match the user request. Alternatively, the selection signal can convey parameters that can be used by a downstream functional block to activate or condition a Generative AI entity such that the user request is processed according to the selection. In one specific example, the selection signal can convey a ranking of the user request in the context of one or several metrics, such as cost, latency, complexity, etc. In other words, the selection signal conveys characteristics of the user request enabling the downstream functional block to choose the Generative AI entity that best matches those characteristics. For instance, the selection signal may convey that cost is a priority, to guide the downstream functional block to select based on that parameter.

The selection signal output by selector mechanism 14 is advisory in nature—it conveys data allowing to activate or select a Generative AI entity that best matches the user's needs. It does not partake in the subsequent steps of managing or processing the user request through the Generative AI entities. Therefore, the responsibility to act upon this information—specifically, to route the user's request to the appropriate Generative AI entity that corresponds with the selection—falls to the user or administrator.

In certain embodiments of the present invention, selector mechanism 14, is configured to evaluate a batch of user requests to determine the most appropriate Generative AI entity or capability for handling the requests within the batch. In this embodiment, mechanism 14 receives a batch of user requests collected over a defined temporal interval, which forms a representative corpus of user requests. This corpus may, for example, be associated with a certain source, such as a particular business organization, under the assumption that requests originating from this source share common characteristics and can be effectively processed by the same Generative AI system. Consequently, the analysis performed on this batch of user requests is expected to be valid to all current user requests from the same source.

The selector mechanism 14 individually processes each request in the batch to identify the Generative AI entity or capability that most closely matches the typical user profile in the corpus. Upon completing this evaluation phase for the batch of user requests, and identifying the appropriate Generative AI entity or capability, future user requests that share the same profile as those in the evaluated batch can be directly routed to the selected Generative AI entity. This systematized approach enhances the handling of similar user requests in subsequent operations.

As disclosed earlier, an option is to configure the selector mechanism 14 to dynamically route user requests to a Generative AI entity, following the evaluation of the user request to determine the requisite performance. In this example, selector mechanism 14 encompasses a routing logic designed to execute this operation. The architecture of said routing logic varies depending upon the organizational structure of the Generative AI entities.

In scenarios where the Generative AI entities operate as discrete network entities, the routing logic is configured to associate each selectable Generative AI entity with a corresponding network address, thereby enabling the dispatch of user requests to that network address for processing. Conversely, in instances where the Generative AI architecture is underpinned by a unified hardware platform hosting a pool of LLM's that can be selectively engaged, the routing logic integrates with the user request, supplemental information that facilitates the identification of the specific LLM to be activated for servicing the user request. Specifically, this supplemental information comprises an indicator that identifies the selected LLM in the pool of LLM's, either directly or in some indirect fashion. In embodiments where the plurality of Generative AI entities function as virtualized entities, the same methodology is employed. The supplemental information conveyed with the user request is processed by the Generative AI platform to condition the platform, such as through prompt engineering to activate the desired virtual Generative AI entity.

FIG. 3 presents a more detailed block diagram of the selector mechanism 14, delineating its principal functional components. The selector mechanism 14 includes an input interface 24 for the reception of user requests and optional additional inputs. The interface 24 enables interaction with the data network responsible for conveying the user request, thereby it is configured to manage data transmissions utilizing appropriate data transport protocols.

The input interface 24 communicates with selection logic 26, which is tasked with processing incoming user requests at the input interface 24 to select a Generative AI entity for appropriate servicing of the user requests. Further details on the architecture and operational dynamics of the selection logic 26 are provided below. This selection logic 26 is in communication with a selector mechanism manager 32, which oversees the functionality of the entire selector mechanism 14. As it will be detailed hereinafter, the selector mechanism manager 32 is configured to modulate the operational characteristics of the selection logic 26 to tailor it to specific user requirements or situational contexts. An illustration of such modulation involves biasing the selection operation to favor certain operational objectives, for instance, reducing operational costs associated with processing particular user requests. In an exemplary scenario, selector mechanism manager 32 can influence the decision-making process of selection logic 26, enabling user request assignment to a Generative AI entity that incurs a lower service cost. This adjustment may result in a compromise on the quality of the response delivered by the Generative AI entity to the said request, but the low-cost requirement is achieved.

The selection logic 26 can use several different mechanisms, operating independently or in conjunction with each other to evaluate user requests, either individually or groupwise when selecting a matching Generative AI entity based on the evaluation.

The selection of a Generative AI entity typically involves considering specific metrics, which are categorized into two main categories: intrinsic metrics and extrinsic metrics, among other possible categories. Intrinsic metrics consider the inherent complexity of a user request, and/or specific attributes of the LLM that define the capabilities of the LLM to deal with user requests. For instance, a user request might be straightforward, involving a simple query expressed in simple terms, or it could be more complex, requiring the LLM to perform intricate operations, such as retrieving relevant contextual information from disparate sources before processing the request. Thus, examples of intrinsic metrics include those that evaluate the complexity of the task assigned to the LLM and/or metrics that evaluate the capability of the LLM to deal with such user requests.

Examples of intrinsic metrics that that reflect the attributes of the LLM, include among others:
1. Creativity and Originality: The LLM's ability to produce work that is not only unique but also shows a level of creativity and originality, moving beyond mere replication of existing patterns.
2. Understanding and Contextualization: The degree to which the LLM can understand the context and nuances of the input to generate coherent and contextually appropriate outputs. This includes the ability to handle complex instructions, grasp subtleties in language or visual cues, and adapt its outputs accordingly.
3. Adaptability and Flexibility: How well the system can generate outputs across a broad range of domains or tasks, showing versatility in its generative abilities. This includes adapting to new or evolving content areas and styles.
4. Quality and Sophistication: The overall quality of the outputs in terms of their sophistication, detail, accuracy, tone, and alignment with human standards of excellence in a given domain.
5. Accuracy: The information provided by the LLM in the response to the user request is factually correct and can be grounded to a source (i.e., information that is not hallucinated).
6. Clarity: The response to the user request is clear, easy to understand, and free from ambiguity.
7. Relevance: The response to the user request addresses the user's query directly and appropriately.
8. Policy Compliance: The response to the user request aligns with an institution's policies and guidelines.
9. Regulatory Compliance: The response to the user request adheres to relevant legal and regulatory standards, particularly important in sectors such as finance.
10. Ethics and Fairness: The response to the user request respects ethical guidelines and does not show bias or discrimination, such as racial bias, gender bias or other undesirable bias.
11. Security/Adversarial Attacks and Privacy: The response does not violate the user's privacy or the institution's security protocols.

Conversely, extrinsic metrics focus on operational parameters that impact the execution of the task but are not inherently tied to the complexity of the user request. These extrinsic metrics encompass aspects such as cost, response time (latency), and other logistical and operational factors. By considering both intrinsic and extrinsic metrics, a more complete assessment of the user requests and available capabilities of the Generative AI systems in the pool is possible.

Examples of extrinsic metrics that relate to operational parameters of the Generative AI system include, among others:
1. Latency to service the user request.
2. Cost-per-token to service the user request,
3. CO2e Emissions for Pretraining and Inference of the LLM,
4. Energy Consumption for Pretraining and Inference of the LLM,
5. Optimization Costs for Customizing Embeddings and Supervised Fine-tuning, Operational Costs for Bandwidth, Compute, Memory and Storage, Monitoring and Update Costs.

Items 3 and 4 can be broadly characterized as being environmental cost factors.

Typically, the attributes of a Generative AI system or the underlying LLM are well-defined and understood in terms of extrinsic and some intrinsic metrics. For instance, with a specific Generative AI system, parameters such as cost-per-token, latency, and environmental impact are established and known. Similarly, in terms of intrinsic metrics, attributes like the system's ability to avoid bias, ensure regulatory compliance, and maintain clarity in responses are well recognized and understood. Therefore, the pool of Generative AI entities, which use diverse LLM's provide a range of operational profiles, and the selection logic 26 will attempt to match user requests to the operational profile which is the best fit for the user request.

The selection of a Generative AI entity by the selection logic 26 is conducted based on intrinsic and/or extrinsic metrics, whereby the user request is ranked according to one or more of these metrics. After the ranking is performed, the selection logic 26 selects, at least in part of that ranking an operational profile among the range of operational profiles, that is the best match for the ranking. For instance, if a user request scores highly on the cost-per-token metric, the selection logic considers this ranking and opts for a Generative AI entity that exhibits a strong performance in accordance with that particular metric. This method ensures that the chosen Generative AI entity aligns with the specific demands and constraints highlighted by the ranking of the metrics. In most applications, however, the selection of the Generative AI entity will be based on multiple metrics, some of which may be conflicting, such as for example low cost on the one hand and the ability to handle complex requests on the other. In this case, the selection logic 26 will try to balance the requirements by identifying among the pool of Generative AI entities, one that performs in an acceptable fashion against all the metrics that are taken into consideration.

The selection logic 26 is designed to process both intrinsic and extrinsic metrics, along with the user request, to select the most suitable Generative AI entity to handle the request. Extrinsic metrics typically function as directives that shape or influence the selection process in accordance with the preferences specified by the user or administrator. Specifically, these intrinsic and extrinsic metrics are delivered to the selection logic 26 through configuration signals. These signals communicate rankings based on various extrinsic and some intrinsic metrics pertinent to an individual user request or a group of user requests, enabling decision-making within selection logic 26.

These configuration signals could convey rankings associated with external metrics like cost-per-token, latency, and environmental impact, which are user-specified. For instance, they might specify that a particular user request should prioritize minimizing environmental impact, by conveying a ranking value denoting low environmental cost. Additionally, these configuration signals could convey rankings regarding internal metrics such as bias management, accuracy, and relevance. For example, if the user or administrator aims to minimize bias in handling user requests, the configuration signals would convey a ranking value for bias management, set by the user or administrator to reflect that intention.

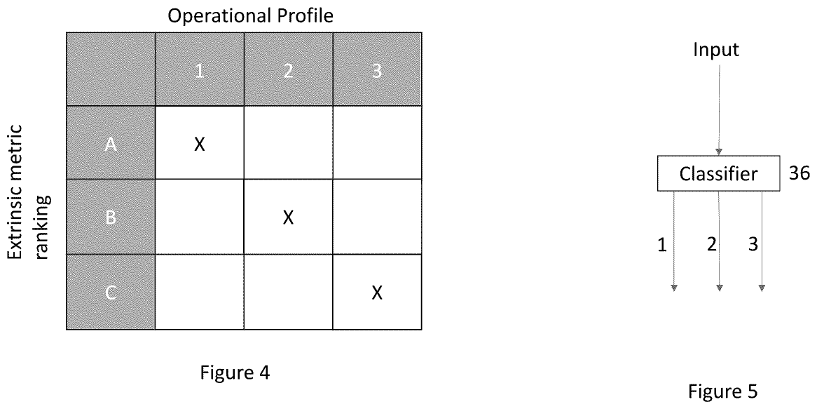

The selection logic 26 can use several different mechanisms, operating independently or in conjunction with each other to select an operational profile for a Generative AI system based on intrinsic and/or extrinsic metrics. FIG. 4 is a high-level block diagram of an example of implementation of a first mechanism. The mechanism includes a look-up table or an equivalent arrangement that maps intrinsic and/or extrinsic parameters ranking to operational profiles. In this example, once the ranking for an intrinsic and/or extrinsic metric is determined or is set, the corresponding operational profile can be extracted from the look-up table.

More detailed examples of extrinsic metrics include the following:
1. Handling latency for user request servicing. Specifically, a user or administrator may establish a maximum permissible latency threshold for responding to user requests. This latency threshold is communicated through the configuration signals by assigning a ranking on the latency metric. Upon receiving these configuration signals, selection logic 26 retrieves an operational profile from a look-up table according to the latency ranking. In the example of the look-up table shown in FIG. 4, three rankings can be assigned to the latency metric: A, B, and C. Ranking A represents the longest allowable wait time for a user request to be serviced, C the shortest, and B an intermediate duration. The look-up table also specifies three selectable operational profiles corresponding to different Generative AI entities, labeled as profiles 1, 2, and 3. For instance, if the latency ranking is “B”, the corresponding operational profile retrieved would be “2”. Assuming selection logic 26 only considers the latency metric when selecting a Generative AI entity, it would then select the entity associated with operational profile “2” to handle the request.
2. Cost/Resource Metrics, such as:
   a. Cost-per-token for prompts and completions. In this example, the user or administrator sets a cost-per-token threshold. The cost-per-token threshold is conveyed via the configuration signals as a ranking on the cost metric. In response to the configuration signal, selection logic 26 extracts from a cost metric look-up table (not shown in the drawings) the corresponding operational profile for the Generative AI entity.
   b. Environmental metrics. In this example, the user or administrator sets an environmental cost threshold. The cost threshold is conveyed via the configuration signals as a ranking on the environmental cost metric. In response to the configuration signal, selection logic 26 extracts from an environmental cost metric look-up table the corresponding operational profile for the Generative AI entity.

It should be noted that in practice, selection logic 26 would include several look-up tables which are associated with different extrinsic and intrinsic metrics. As a certain user request is received by the selection logic 26, the selection logic 26 first identifies the look-up tables that corresponds to the extrinsic and intrinsic metrics and then extracts the corresponding operational profiles from the look-up tables. The selection logic 26 then selects among the extracted operational profiles, one considered the best compromise for the different rankings.

In the case of intrinsic metrics, an assessment of the user request is optionally performed to rank the request against one or more intrinsic metrics. The assessment involves processing the user request to assess its content and overall complexity. Several possibilities exist to assess the user request.

One example is to use a neural network-based classifier 36 depicted conceptually in FIG. 5. Classifier 36 forms an integral component of the selection logic 26 and is specifically adapted to receive and process tokens derived from a user request. The architecture of classifier 36 is such that the tokens are input, whether sequentially or in an alternative arrangement, to perform classification. Classifier 36 has a plurality of outputs, each output corresponding to a discrete rank, such as rank 1, rank 2, and rank 3, etc. These ranks are established in accordance with an intrinsic metric. Upon receipt of a user request, classifier 36 processes the input tokens and subsequently activates the output that most closely corresponds to the intrinsic characteristics of the request.

Furthermore, in scenarios where the user request necessitates ranking against multiple intrinsic metrics, a plurality of classifiers 36 are employed, each classifier receiving the stream of tokens. Each classifier within this plurality is uniquely associated with a specific intrinsic metric, thereby enabling tailored classification based on the metric relevant to each user request.

For proper operation, the classifier 36 arrangement necessitates training. This training is accomplished through established AI training methodologies, involving the provision of training data to adjust the weights and biases of the neural network, thereby enabling it to emulate the decision-making process when presented with new input data. The training data utilized for this purpose may entail establishing correlations between user requests and corresponding rankings.

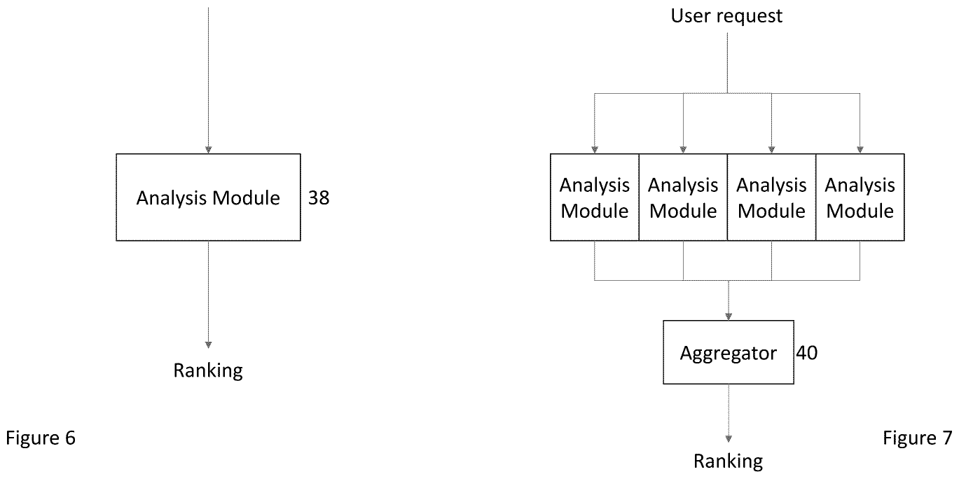

A variant, which avoids the necessity of providing training data relies on analytical techniques to process the user request and gain a deeper understanding of the complexity and sophistication of textual content across various domains. FIG. 6 illustrates the computer implemented architecture of this variant. Selection logic 26 is provided with a user request analysis module 38 which is software implemented to perform analysis of the user request. Examples of analysis techniques that can be implemented by the analysis module 38 include:
1. Historical Precedence of the Request: This approach involves assessing the similarity of a user request text against historical requests in order to reuse a predetermined logic (cached) selection decision. Measures such as TF-IDF (Term Frequency-Inverse Document Frequency) facilitate the identification of words that exhibit relative uniqueness within a specific text compared to a broader corpus. In this instance, the analysis assesses the prevalence of uncommon words within the user request. A higher frequency of uncommon words, in comparison to a broader corpus, suggests a net-new request with no historical precedence. For similar requests, a cached decision could be leveraged to speed up the selection response.
2. Readability Scores: Readability scores, such as Flesch-Kincaid Grade Level, Gunning Fog Index, or Coleman-Liau Index, assess the complexity of a text based on factors like sentence length and word complexity. Higher scores indicate more complex texts. In the readability score analysis example, the system is designed such as to attribute discrete ranks for respective readability score thresholds.
3. Lexical Density: Lexical density measures the proportion of content words (nouns, verbs, adjectives, and adverbs) compared to function words (pronouns, articles, prepositions, etc.). More sophisticated texts typically have higher lexical density.
4. Syntactic Analysis: Examining sentence structures can shed light on the complexity level of a text. Advanced texts often contain intricate sentence configurations, such as the inclusion of subordinate clauses and a variation in sentence lengths. Through syntactic analysis, sentences within a user request can be evaluated for their level of sophistication. For instance:
   a. Sentences can be assessed for their syntactic complexity, which might include examining the number of clauses, the parse tree's depth (indicating the sentence's syntactic structure), or the complexity of used syntactic constructions. Sentences featuring multiple clauses or extensive parse trees are considered more complex and might be rated higher in situations where such complexity is associated with depth or informational value. The higher a sentence's ranking, the more sophisticated the user request is perceived, necessitating a more capable Generative AI entity.
   b. The grammatical accuracy of sentences can also influence their ranking. Sentences without grammatical errors receive higher rankings.
   c. The degree of ambiguity in a sentence, reflecting multiple possible syntactic interpretations, can affect its ranking. In specific scenarios, more ambiguous sentences might be ranked higher as they pose greater processing challenges, indicating the need for a more sophisticated Generative AI entity.
5. Semantic Analysis: Semantic analysis examines the meaning of words and phrases in context. Tools like WordNet can be used to identify synonyms, antonyms, and semantic relationships, helping to assess the richness and depth of vocabulary usage. A user request using rich vocabulary will rank higher, which implies a more sophisticated Generative AI entity.
6. Topic Modeling: Topic modeling techniques such as Latent Dirichlet Allocation (LDA) can uncover underlying themes or topics within a text. Sophisticated texts may cover a wide range of topics or exhibit nuanced discussions on specific subjects. Accordingly, a user request that scores high in a topic modeling analysis, will rank high in terms of Generative AI sophistication required to properly service the user request.
7. Named Entity Recognition (NER): NER identifies and categorizes named entities such as people, organizations, and locations in a text. The presence of diverse and specialized named entities can indicate text sophistication, hence higher ranking in terms of Generative AI entity performance.
8. Sentiment Analysis: Sentiment analysis determines the overall sentiment or tone of a text, which can provide insights into its complexity and sophistication. Sophisticated texts may present nuanced or ambivalent sentiments and may require more sophisticated Generative AI entity for processing.
9. Stylistic Analysis: Stylistic features such as metaphor, irony, and figurative language can contribute to text sophistication. Analyzing these elements can reveal the level of literary or rhetorical sophistication in a text. A user request that scores high in terms of stylistic analysis will likely require a more sophisticated Generative AI entity to properly service this request.
10. Task at Hand: Complexity of the task articulated in the request, such as summarization, question answering, or inferencing. Intricate tasks that require multiple subtasks (e.g., text comprehension, computer vision, source code execution, calculations, and summarization) are more complex to fulfill than tasks that have one action (e.g., summarization-only).

The user's request is thus forwarded to analysis module 38, where it undergoes processing based on the chosen analysis technique, resulting in an output. In one example, the output conveys a ranking in relation to an intrinsic metric. In a variant shown at FIG. 7, the selection logic 26 implements a range of analysis modules, each being associated with a respective analysis technique and each generating output. An aggregator module 40 combines the outputs to generate a ranking for a certain intrinsic metric developed on the basis of several individual analysis techniques.

As an illustration, the aggregator module 40 may employ algorithmic processes to compute the average of the outputs generated by the individual analysis modules. This methodology is effective when the various analysis techniques executed by the respective modules are perceived to possess comparable significance in assessing the sophistication of the user's request. Conversely, in cases where certain analysis techniques are deemed to hold greater relevance than others, a weighted average approach may be employed.

In practical terms, conducting an in-depth analysis of the user request to evaluate its complexity yields valuable insights and facilitates directing the request to the most suitable Generative AI entity for servicing. Nonetheless, this approach introduces a computational overhead to the overall process.

Additionally, certain techniques involved in this analysis may possess computational intricacies, rendering real-time execution unpractical. Put differently, if each user request that is received by the system undergoes analysis to generate a ranking and subsequently select the most appropriate Generative AI entity based on this ranking, the process could result in excessive latency and computational expense for servicing the user request.

Real time processing could still be possible if the analysis technique chosen is simple to implement and does not impose an extensive computational burden.

Once the ranking against one or more intrinsic metrics is determined for a user request, a look-up table can be used to determine the corresponding operational profile of a Generative AI system best suited to service the user request.

Instead of real-time processing, the intrinsic analysis techniques could be applied to samples of user requests to statistically evaluate which Generative AI entity is most suitable for servicing those requests and by extension, request like the ones being evaluated. In a specific instance, from the stream of requests received by system 10, a subset undergoes analysis utilizing the aforementioned techniques. The appropriate selection of Generative AI entities for these requests can then inform the handling of other user requests with similar complexity. An illustrative application of this approach involves sampling user requests originating from a single source, under the assumption that requests from the same origin share comparable complexity levels and demand similar performance standards from the Generative AI entity for effective servicing. For instance, a single source might represent a specific business entity, such as a financial institution, where requests typically pertain to financial themes, likely requiring a higher level of sophistication in servicing and less randomness compared to requests from entities in the leisure industry, for example.

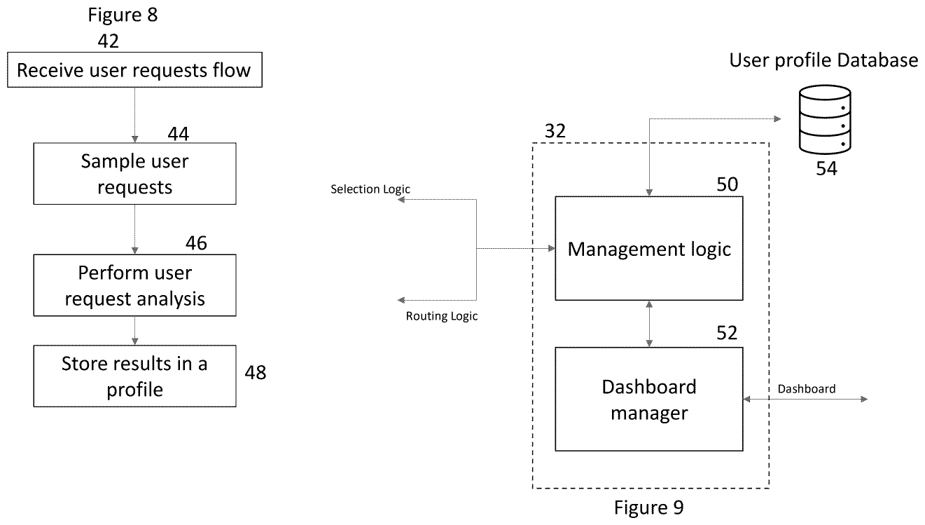

FIG. 8 is a flowchart that shows the steps performed by the selection logic 26 to perform such sampling and analysis. At step 42 of the process a flow of user requests is received at the input of the Generative AI entity 10, where the user requests originate from different network locations. Among those user requests, some will be simple while others will be much more complex. At step 44 the selection logic 26 samples requests from the flow at a set rate. For example, one user request out of every 10 user requests is retained for analysis. One possibility is to let each user request flow through and be serviced in the way system 10 is set, in other words direct the user request to a selected one of the Generative AI entities, and merely a copy of the user request is made for analysis. In this fashion, the analysis operation is transparent to the user, in the sense that the user sees no additional latency in the delivery of the results. Alternatively, to the extent latency is not an issue that could inconvenience the user, the processing of the sampled user requests can be interrupted pending the analysis and identification of the most appropriate Generative AI entity for service the requests.

At step 46, the analysis of each sampled user request is conducted, employing intrinsic and/or extrinsic metrics as previously discussed. Subsequently, the sampled requests and their corresponding rankings undergo further processing, such as by employing statistical analysis to extrapolate these results to future user requests anticipated by system 10 that exhibit similarities to the sampled ones. For instance, the logic can be configured to ascertain the source of each sampled request and link the rankings derived from sampled user requests originating from a specific source to all future user requests expected from that source.

At step 48, the determined rankings are stored within a profile, which, in the aforementioned scenario, may be a user profile associated with the origination node in the network of the user request. The profile is implemented by a structured dataset storing intrinsic and or extrinsic metric rankings to be applied to user requests from this origination node. Consequently, when a user request is received from the origination node, the rankings are applied to the processing of the user request. Practically, the user profile may comprise a look-up table mapping origination nodes to corresponding intrinsic and/or extrinsic metrics.

Referring to the block diagram shown in FIG. 3, selector mechanism 14 comprises a selector mechanism manager 32 overseeing the operation of the selection logic 26. Specifically, the selector mechanism manager 32 is designed to fulfill two primary roles.

Firstly, it adjusts the operation of the selection logic 26 to ensure its adaptability. For instance, a user might prioritize cost considerations over the sophistication of outputs provided by the Generative AI entity in serving a user request. In such cases, the selector mechanism manager 32 is configured to modify parameters within selection logic 26, giving precedence to cost considerations.

Secondly, the selector mechanism manager 32 facilitates communication with a user or administrator, providing a reporting function and communicating to the user or administrator information regarding the selection logic 26's operation and accepting inputs from the user or administrator. These inputs may include the configuration signals previously mentioned, that convey directives aimed at biasing the operation of selection logic 26 towards various aspects of its operational spectrum, as indicated above.

A block diagram of the selector mechanism manager 32 is shown in greater detail in FIG. 9. The selector mechanism manager 32 includes a management logic functional block 50 and a dashboard manager functional block 52, which communicates with the management logic functional block 50. The management logic functional block 50 also communicates with a user profile database 54, the selection logic 26 and with routing logic 28. The dashboard manager 52 communicates with a device (not shown in FIG. 9) that implements a dashboard and allows a user or administrator to input data.

An example of such a device is a user computer including a display to show the dashboard representation and a pointing device or another input mechanism allowing the user or administrator to generate inputs.

The dashboard manager 52 implements a dashboard software application. The dashboard software application is configured to display via a GUI an operational state of the selector mechanism 14. A GUI is a user interface that allows the user or administrator to interact with the dashboard software application through graphical icons and visual indicators, among other types of input control elements. GUIs (Graphical User Interface) make it easier for the user or administrator to manipulate and navigate the dashboard software application by providing intuitive, visually engaging elements like buttons, windows, and menus.

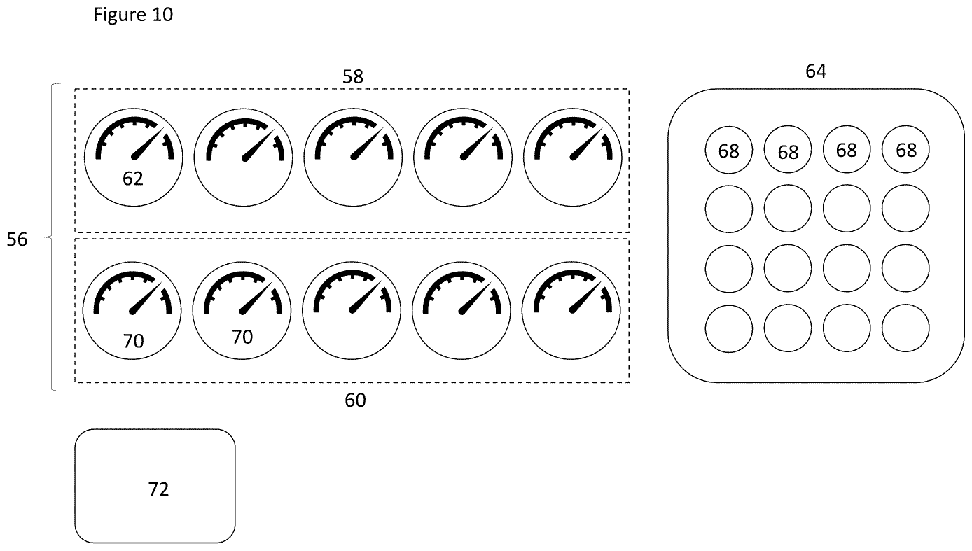

In the disclosed embodiment the GUI illustrated in FIG. 10 is comprised of a primary display region 56, which is specifically designed to present the outcomes of evaluations conducted on user inputs by the selection logic 26. In greater detail, the configuration of display region 56 enables the communication of assessed rankings to the user or administrator, with these assessments being based on specific metrics.

Further, in the exemplary embodiment illustrated in FIG. 10, the primary display area 56 is segmented into two distinct sub-regions, labeled 58 and 60. Sub-region 58 is dedicated to displaying results related to intrinsic metrics, while sub-region 60 pertains to extrinsic metrics. Consequently, when selection logic 26 conducts assessments on intrinsic metrics, the results of those assessments are visually rendered within sub-region 58. Similarly, evaluations or user settings on extrinsic metrics are displayed within sub-region 60. This structured display arrangement facilitates a clearer understanding and monitoring of different metrics by the user or administrator.

Sub-region 58 is provided with a plurality of individual display elements 62, each correlated with a specific metric. Typically, the number of display elements 62 corresponds directly to the number of metrics being assessed or used. Each display element 62 is structured to visually represent the assessed ranking for its respective metric relative to a given reference or scale, thereby facilitating immediate visual comparison of data differences.

Optionally, each display element 62 is associated with a label to denote the corresponding metric. Consequently, upon processing a user request by the selection logic 26, which evaluates a ranking with respect to a particular metric, the resulting ranking is visually communicated through the dashboard application, which then configures the associated display element 62 accordingly. In an alternative embodiment, rather than employing a visual representation based on a reference or scale, the display element 62 can be adapted to numerically present the ranking, providing a direct quantitative display of the ranking.

While the intrinsic metrics visually present results derived from assessments performed on user requests, the extrinsic metrics are mostly linked to desired outcomes such as cost-per-token, latency, and environmental impact, among others. Thus, for most extrinsic metrics, the data displayed typically represents user settings that convey instructions or preferences concerning these metrics. Those instructions or preferences are one example of the configuration signals with adapt or configure the operation of the selection logic 26.

The configuration signals, in the form of user instructions or preferences may also be embedded within the user request at the source node. In other words, the source node that issues the user request includes a functionality to convey with the user request or separately from the user request data conveying one or more rankings in relation to intrinsic metrics to be applied when servicing the user request. Alternatively, as mentioned earlier, the metrics may be stored within a user profile in the user profile database 54. In scenarios where a user request can be linked with a user profile, the extrinsic metrics stored in the user profile are retrieved and sent to selector mechanism 14 to condition the selector mechanism 14, accordingly. The metrics retrieved from the user profile are displayed in sub-region 60, reflecting the user's specified preferences or instructions regarding the extrinsic metrics.

One way to operationally link user requests with corresponding user profiles in the user profile database 54 is to associate the user requests with identifiers which map to user profiles. In a specific example, the identifier of the user request can represent or describe the origin node where the user request originated. In this form of implementation, the user profiles are mapped to origination nodes in the data network. The process thus involves receiving the user request, reading the identifier associated with the user request, mapping the identifier to a user profile, retrieving one or more rankings from the user profile, and applying those rankings to the selector mechanism 14.

The GUI additionally comprises a control elements area 64 that incorporates a plurality of individual control elements 68. These control elements 68 are configured to be operable by a user or administrator to output configuration signals to adjust the operational characteristics of the selector mechanism 14. Specifically, the control elements 68 facilitate the user or administrator's ability to bias the functionality of the selector mechanism 14 towards certain parameters within the operational envelope, for example, optimizing for cost-per-token and/or latency when servicing user requests, among others. Each individual control element 68 may comprise distinct types of user interface components suitable for allowing the user or administrator to specify desired rankings for specific metrics. Such interface components can include sliders, buttons, and menus.

Moreover, each individual control element 68 associated with a specific metric is marked with a label corresponding to that metric to facilitate easy identification by the user or administrator.

Operationally, the individual control elements 68 are linked to the display region 60, wherein each control element 68 is associated with a corresponding display element 70 within said display region 60. This association operates in a way that any adjustment made via a control element 68 is directly reflected on its corresponding display element 70. Typically, each display element 70 includes an indicator situated on a scale; movement of this indicator along the scale visually represents the ranking of the associated metric, thereby providing immediate feedback on adjustments made via the control elements 68. With this arrangement the user or administrator can dial-in desired rankings on one or more metrics, to bias the operation of the selector mechanism 14, accordingly.

Note that one or more of the control elements 68 can also be associated with intrinsic metrics. Extrinsic metrics are those preset by the user or administrator, encompassing performance outcomes deemed essential or preferred. A prominent example of an extrinsic metric is the cost-per-token, wherein its corresponding control element 68 allows the user or administrator to set the cost-per-token governing the utilization of the Generative AI entity. Another key extrinsic metric is latency, directly influencing the end-user's perception of system responsiveness.

The control elements 68 associated with extrinsic metrics predominantly serve the user or administrator in generating the configuration signals for configuring the extrinsic operational parameters of the system. Conversely, intrinsic metrics, as manifested through display elements 62, encapsulate evaluations of individual user requests in terms of sophistication. However, the associated control elements 68 allow the user or administrator to bias or alter intrinsic metric rankings generated by the user request's evaluation.

This functionality permits the selection logic 26 to select a Generative AI entity for servicing the request, where the selection is such that certain capabilities of the Generative AI entity are prioritized based on certain specified intrinsic metrics. For example, the user or administrator may want to boost through the corresponding control element 68 the ranking of the user request on a Readability Analysis test such as to bias the selection of the Generative AI entity for servicing this request toward one having a proficiency in handling user requests with a high score on a Readability Analysis test.

The dashboard is further provided with a designated display area 72 that is driven by the selection signal output by the selection logic 26 and in this example operating to identify the Generative AI entity which the selection logic 26 either activates automatically or recommends. The display area 72 can identify the chosen or recommended Generative AI entity utilizing a name or any alternative suitable identifier, thereby facilitating direct visibility for the user or administrator into which Generative AI entity has been recommended for that user request(s) or activated for processing said user requests.

This visual feedback is particularly advantageous in scenarios where the selector mechanism 14 operates merely in an advisory role, to identify the most appropriate Generative AI entity that meets specific user requirements articulated through intrinsic and extrinsic metrics. After this advisory output, the user or administrator must configure the IT platform, ensuring user requests are routed to the recommended Generative AI entity.

Moreover, in instances where the selector mechanism 14 possesses the functionality for routing the user request to the selected Generative AI entity in the pool, whereby the selected Generative AI entity is activated to address the user request, the display area 72 provides an indication of the Generative AI entity engaged in servicing the request. Beyond mere visual identification of the engaged Generative AI entity, the dashboard application managing the dashboard is further configured to accumulate data concerning which Generative AI entity has been activated for servicing requests. This capability enables the performance of statistical analyses, which include, but are not limited to:
1. Frequency of Usage Analysis: This involves quantifying the frequency with which each Generative AI entity within the available pool is utilized. The results of this analysis may be graphically represented in a frequency of usage graph, which illustrates how often a particular Generative AI entity is employed relative to others within the pool.
2. Temporal Analysis of Usage Patterns: This analysis determines the usage patterns of a Generative AI entity with respect to time-of-day or seasonal variations. Such insights disclose the characteristics of user requests generated during specific time periods. For example, pronounced usage of a specific Generative AI entity during morning hours indicates that the user requests are predominantly aligned with the capabilities of that system, unlike those during afternoon or evening hours. This data is valuable as it provides a deeper understanding into the varying complexity or sophistication of user requests throughout the day. Consider a financial institution receiving user requests, such as financial inquiries. If many of these requests in the morning trigger a specific Generative AI entity, whereas afternoon requests activate a different system, such information enables the financial institution to deduce the level of sophistication between the morning queries versus the afternoon ones, potentially indicating a variance in the clientele between these time periods.
3. Location-aware Analysis of Usage Patterns: Another embodiment of the usage pattern analysis includes incorporating location information associated with the source of the user request. By correlating the chosen Generative AI entity with the geographic location of the user request—assuming availability of such location data—it becomes feasible to ascertain the sophistication level of user requests across diverse locations.

Referring to FIG. 9, dashboard manager 52 interfaces through management logic 50 with the user profile database 54. This database stores the user-specific information, particularly settings for metrics conveyed to selection logic 26 via the configuration signals to determine an appropriate Generative AI entity for a given user. The user profile database 54 is implemented by a memory storage device, which may be hosted in the cloud or locally, featuring either a distributed or centralized architectural configuration. Each user profile is allocated a specific memory location, identifiable by unique identifiers. The memory location associated with a specific user profile retains settings for various metrics that govern the functionality of selector mechanism 14. These settings represent values assigned by either the user or the administrator to the respective metrics, configuring the operations of selector mechanism 14 to align with user preferences.

Upon receipt of a user request at the input of selector mechanism 14, the settings of selector mechanism 14 are thus configured by supplying the configuration signals including a range of rankings associated with different extrinsic and/or intrinsic metrics, where the rankings can be explicitly specified by the user or administrator, assessed by evaluating the user request and optionally individually boosted or depressed.

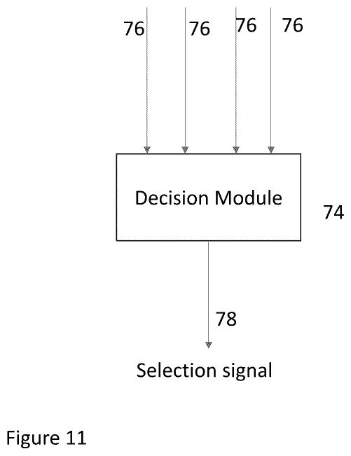

FIG. 11 illustrates a block diagram of another functionality of the selection logic 26 configured to select a Generative AI entity, in a pool of Generative AI entities based on multiple ranking inputs where the rankings are associated with different metrics. In this example of implementation, the selection logic 26 includes a decision module 74 that includes several inputs 76, where each input receives a ranking in association with a certain metric. The decision module 74 will have as many inputs 76 as there are metrics characterizing the user request. The decision module has an output 78 which outputs the selection signal. In this example, the selection signal conveys a selection of the Generative AI system identified by the decision module 74 as best suited for servicing the user request based on the rankings applied at the inputs 76. When a pool of Generative AI entities is available for selection, the decision module 74 picks one Generative AI entity in the pool that is the optimal choice for the characterization of the user request conveyed by the rankings 76.

In one example of implementation, the decision module includes a classifier based on a neural network. The classifier includes the inputs 76 and a range of individual outputs, where each output corresponds to a Generative AI entity in the pool. The outputs can be selectively activated, where the activation of a particular output constitutes a selection signal which designates the Generative AI entity associated with the active output.

The classifier accepts the inputs 76 corresponding to the different rankings, processes them and activates one of the outputs which corresponds to the Generative AI entity that best fits the rankings pattern input into the classifier. To perform this function, the classifier requires training which is achieved via training data. The training data includes a training data set which has multiple data pairings. A data pairing includes a set of rankings and a corresponding Generative AI entity that has been previously identified as being a best match for that particular ranking pattern. The training data is used to configure the neural network through known training techniques. The volume of training data, particularly the volume of data pairings, can vary; however, it is recognized that the larger the data set, the more accurate the operation of the classifier. The training data can also include a validation data set to validate the operation of the classifier once the training is completed.

A classifier architecture for the implementation of the decision module 74 is simple and cost effective to operate, however it requires training data, which may be time consuming and costly to obtain. Also, the training data is somewhat specific to the pool of Generative AI entities. If the pool changes by addition of new Generative AI entities, removal of Generative AI entities or changing the characteristics of one or more Generative AI entities in the pool, retraining of the classifier will likely be necessary such that its operation continues to be matched to the entities in the pool. Accordingly, the classifier architecture is likely to require periodic retraining.

In a variant, the decision module 74 using the classifier architecture includes a feedback mechanism to provides continual retraining and as such improve the alignment between the Generative AI entities and the rankings patterns. The feedback mechanism may involve a human observing the selections made by decision module 74 and identifying those that are not optimal. Based on those observations, additional training data is generated to improve the operation of the classifier.

Another method of implementation of the decision module 74 is to use a characterization system for the different Generative AI entities, based on the extrinsic and/or intrinsic metrics. The characterization system includes a plurality of profiles associated with respective ones of the Generative AI systems, where each profile identifies the performance level of the Generative AI entity in relation to one or more rankings. For example, the profile for a certain Generative AI entity can include a series of ranks, associated with the same extrinsic and/or intrinsic metrics used to characterize the user requests, where the different ranks in the profile indicate the degree of performance of the Generative AI entity in relation to the particular metric. An example of a rank can be cost per token, where a ranking of 9 on a scale of 1 to 10 indicates that the Generative AI entity is performing highly in relation to the cost per token metric.

In this implementation the decision module 74 may identify the optimal Generative AI entity by performing series of similarity measurements for several metrics, by comparing the ranking of the user request and the ranking in the profile of each Generative AI entity, for the different metrics, and selecting the Generative AI entity where the similarity is highest.

1. A non-transitory computer-readable storage medium, comprising instructions which, when executed by one or more processors, configure the one or more processors to implement a Generative AI entity selector mechanism for selecting a Generative AI entity to service a user request, among a set of Generative AI entities, the selector mechanism including:
a. an input configured for receiving the user request;
b. selection logic configured for processing the user request and to generate as a result of the processing a selection signal,
c. an output for releasing the selection signal.

2. The non-transitory computer-readable storage medium as defined in claim 1, wherein the selection logic is configured to derive at least in part from the request the selection signal, wherein the selection signal conveys an identification of the Generative AI entity selected among the set of Generative AI entities.

3. The non-transitory computer-readable storage medium as defined in claim 1, wherein the selection logic is configured to process a configuration signal that influences the selection of a Generative AI entity from the set of Generative AI entities.

4. The non-transitory computer-readable storage medium as defined in claim 2, wherein the request is associated with a particular user, the selector mechanism is configured to store an interaction history between the user and a particular one of the Generative AI entities.

5. The non-transitory computer-readable storage medium as defined in claim 1, wherein the selector mechanism includes routing logic responsive to the selection signal to route via a data network the user request to the Generative AI entity selected from the set of Generative AI entities.

6. The non-transitory computer-readable storage medium as defined in claim 1, wherein the selection logic conveys an association between the user request and a plurality of metrics.

7. The non-transitory computer-readable storage medium as defined in claim 6, wherein the plurality of metrics includes intrinsic metrics.

8. The non-transitory computer-readable storage medium as defined in claim 7, wherein the plurality of metrics includes extrinsic metrics.

9. The non-transitory computer-readable storage medium as defined in claim 7, wherein the selection logic is configured to process the user request to derive a ranking against one or more of the intrinsic metrics.

10. The non-transitory computer-readable storage medium as defined in claim 9, wherein the selection logic includes a neural network-based classifier to derive the ranking.

11. A non-transitory computer-readable storage medium, comprising instructions which, when executed by one or more processors, configure the one or more processors to:
a. implement a Generative AI entity selector mechanism, including:
i. an input configured for receiving a user request intended for a Generative AI entity to elicit an output from the Generative AI entity;
ii. selection logic configured for generating a selection signal conveying a selection of one or more Generative AI entities among a plurality of Generative AI entities for servicing the user request, and output the selection signal via an output
b. implement a Generative AI entity selector monitor configured to output data conveying one or more characteristics of an operation of the Generative AI entity selector.

12. The non-transitory computer-readable storage medium as defined in claim 11, wherein the data conveying the one or more characteristics defines a usage profile of the use of the plurality of Generative AI entities wherein the usage profile establishes comparative frequency of utilization metrics among the plurality of Generative AI entities.

13. The non-transitory computer-readable storage medium as defined in claim 12 wherein the data conveying the one or more characteristics conveys information about cost incurred for using one or more of the Generative AI entities.

14. The non-transitory computer-readable storage medium as defined in claim 12, the data conveying the one or more characteristics establishes comparative cost metrics of utilization among the plurality of Generative AI entities.

15. The non-transitory computer-readable storage medium as defined in claim 12, wherein the data representative of the one or more characteristics establishes comparative latency metrics among the plurality of Generative AI entities.

16. The non-transitory computer-readable storage medium as defined in claim 11, implementing a dashboard application providing a dashboard interface for allowing a user to visualize the data conveying the one or more characteristics.

17. A non-transitory computer-readable storage medium, comprising instructions which, when executed by one or more processors, configure the one or more processors to:
a. implementing a GUI for allowing a user to control a behavior of a Generative AI entity selector mechanism;
b. implementing on the GUI an input mechanism that provides a plurality of selection choices to modify an aspect of the behavior exhibited by the Generative AI entity selector;
c. in response to user selection of a choice among the plurality of choices, deriving a configuration signal that influences a selection of a Generative AI entity among a plurality of Generative AI entities, by the Generative AI entity selector mechanism.

18. The non-transitory computer-readable storage medium as defined in claim 17, wherein the plurality of selection choices includes a selection choice configured to bias an operation of the Generative AI entity selector in favor of a lower cost of operation.

19. The non-transitory computer-readable storage medium as defined in claim 17, wherein the plurality of selection choices includes a selection choice configured to bias an operation of the Generative AI entity selector in favor of a lower latency.

20. The non-transitory computer-readable storage medium as defined in claim 17, wherein the GUI is configured to display a usage profile of the selector mechanism.
